(19) United States
(12) Patent Application Publication
(10) Pub. No.: US 2026/0194334 A1
(43) Pub. Date: Jul. 9, 2026

(54) METHOD FOR MANUFACTURING AN EMBEDDED ELECTRONIC FIREWORD IGNITER

(71) Applicant: IGNITE Firing Systems LLC, Ganesvoort, NY (US)

(72) Inventors: Scott Smith, Gansevoort, NY (US); Caleb Drew Miller, Rockville, MD (US)

(21) Appl. No.: 19/556,123

(22) Filed: Mar. 4, 2026

Related U.S. Application Data
(63) Continuation-in-part of application No. 18/662,047, filed on May 13, 2024, now Pat. No. 12,584,718.
(60) Provisional application No. 63/578,035, filed on Aug. 22, 2023.

(51) Int. Cl. F42C 19/12; F42B 4/30; F23Q 7/02

(52) U.S. Cl. CPC F42C 19/12; F42B 4/30; F23Q 7/02

(57) ABSTRACT

A fuse-less ignition system for fireworks. An ignitor module is provided that is insertable into a firework and includes: a first end exposing a pair of electrical conductors configured for receiving a plug and a second end having a perimeter wall that defines a recessed opening into which the pair of electrical conductors extend; a heating element positioned across the recessed opening in contact with the pair of electrical conductors; an insertable structure secured within the recessed opening, wherein the insertable structure includes a cavity with a hole at an inner end that exposes a portion of the heating element, and wherein the inner end secures the heating element in position; and a pyrotechnic material placed within the cavity of the insertable structure and being adapted to ignite in response to heat energy generated by the heating element.

### PRIORITY CLAIM

This application claims priority to co-pending US application serial number 18/662,047 filed on May 13, 2024, which claims priority to provisional application serial number 63/578,035, filed on August 22, 2023, both entitled EMBEDDED ELECTRONIC FIREWORK IGNITER, the contents of which are hereby incorporated by reference.

### BACKGROUND

Traditionally, electronic firework firing systems utilize a pair of wires with a clip-on style fastener or the like (e.g., talon ignitors) that clips-on to a fuse of the firework. In operation, the firing system outputs an electrical charge that is delivered via the wires to a high resistance element within the fastener, which becomes heated and ignites the fuse of the firework.

### SUMMARY

Aspects of the present invention provide an ignitor module insertable into a firework that eliminates the need for fuses and talons.

In one aspect, the ignitor module includes: a first end having an interface configured for exposure on an exterior surface of the firework, the interface configured for receiving a plug; a set of electrical contacts adapted to receive electrical current from the plug; a heating element coupled to the electrical contacts and adapted to convert electrical energy to heat energy in response to receiving electrical current; and a second end having an ignition element located adjacent to the heating element that includes a pyrotechnic material, the pyrotechnic material adapted to ignite in response to heat generated by the heating element.

In other aspects, the invention includes a firework with an ignitor module embedded therein. The firework includes: an ignitor module insertable into a firework, having:

a first end having an interface configured for exposure on an exterior surface of the firework, the interface configured for receiving a plug; a set of electrical contacts adapted to receive electrical current from the plug; a heating element coupled to the electrical contacts and adapted to convert electrical energy to heat energy in response to receiving electrical current; and a second end having an ignition element located adjacent to the heat element that includes a pyrotechnic material, the pyrotechnic material adapted to ignite in response to heat generated by the heating element.

In a further aspect, an ignitor module insertable into a firework is provided that includes: a first end having an interface configured for exposure on an exterior surface of the firework, the interface configured for receiving a plug; a set of electrical contacts adapted to receive electrical current from the plug; a second end having a heating element coupled to the electrical contacts and adapted to generate heat in response to receiving electrical current; and wherein the heating element is configured to directly ignite pyrotechnic material in the firework.

In still further aspects, an ignitor module insertable into a firework is provided, comprising: ignitor module insertable into a firework, comprising: a first end exposing a pair of electrical conductors configured for receiving a plug and a second end having a perimeter wall that defines a recessed opening into which the pair of electrical conductors extend; a heating element positioned across the recessed opening in contact with the pair of electrical conductors; an insertable structure secured within the recessed opening, wherein the insertable structure includes a cavity with a hole at an inner end that exposes a portion of the heating element, and wherein the inner end secures the heating element in position; and a pyrotechnic material placed within the cavity of the insertable structure and being adapted to ignite in response to heat energy generated by the heating element.

In other aspects, a method for manufacturing an ignitor module is provided, comprising: forming a component having a first end exposing a pair of electrical conductors configured for receiving a plug and a second end having a perimeter wall that defines a recessed opening into which the pair of electrical conductors extend; placing a heating element laterally across the perimeter wall such that the heating element aligns with and contacts the pair of electrical conductors; inserting an insertable structure into the recessed opening, wherein the insertable structure includes a friction-held component that contacts an inner surface of the perimeter wall to secure the insertable structure in place and includes a hole at an inner end that exposes the heating element; and placing a pyrotechnic material in a cavity of the insertable structure.

In another aspect, the invention includes a modular ignitor insertable into a firework, comprising: a socket component having a first end exposing a pair of electrical conductors configured for receiving a plug and a second end having a perimeter wall that defines an opening and exposes the pair of electrical conductors; a base component insertable into the opening of the socket component; and an ignition component mountable within a recessed opening of the base component, wherein the ignition component includes a pair of wires having ignition ends and conductive ends, wherein the ignition ends include a heating element coupled therebetween, and wherein the conductive ends of the pair of wires are configured to extend through the base component; wherein the conductive ends of the pair of wires electrically couple to the pair of electrical conductors in the opening of the socket component.

In another aspect, the invention includes a method of assembling a modular ignitor for a firework, comprising: providing a socket component having a first end exposing a pair of electrical conductors configured for receiving a plug and a second end having a perimeter wall that defines an opening and exposes the pair of electrical conductors; inserting an ignition component into a recessed opening of a base component, wherein the ignition component includes a pair of wires having ignition ends and conductive ends, wherein the ignition ends include a heating element coupled therebetween, and wherein the conductive ends of the pair of wires are extended through the base component; and inserting the base component into the opening of the socket component, wherein the conductive ends of the pair of wires of the ignition component electrically couple to the pair of electrical conductors in the opening of the socket component.

In other aspects, the invention includes a firing system that includes a firing module, a set of wires, each connectable to the firing module on one end and have a plug on an opposite end; and a set of fireworks with ignitor modules embedded therein.

### BRIEF DESCRIPTION OF THE DRAWINGS

These and other features of this disclosure will be more readily understood from the following detailed description of the various aspects of the disclosure taken in conjunction with the accompanying drawings in which:

FIG. 1 shows an ignitor module, firework and plug according to embodiments.

FIG. 2 shows a front view of a firework with an ignitor module installed therein according to embodiments.

FIG. 3 shows a side view of the firework of FIG. 2 with a plug and firing module connected to the ignitor module according to embodiments.

FIG. 4 shows an isometric view of an ignitor module depicting details of a connection interface according to embodiments.

FIG. 5 shows a side cutaway view of the ignitor module of FIG. 4 according to embodiments.

FIG. 6 shows a further isometric view of the ignitor module of FIG. 4 according to embodiments.

FIG. 7 shows a isometric view of an alternative ignitor module according to embodiments.

FIG. 8 depicts a further side cutaway view of the ignitor module according to embodiments.

FIGS. 9 depicts a first exploded view of the ignitor module with a heating element being installed according to embodiments.

FIG. 10 depicts a second exploded view of the ignitor module with an insertable structure being installed according to embodiments.

FIG. 11 depicts a further view of the ignitor module with the insertable structure installed according to embodiments.

FIG. 12 depicts a still a further view of the ignitor module with pyrotechnic material installed according to embodiments.

FIG. 13 depicts an alternative end of ignitor module according to embodiments.

FIG. 14 depicts a further alternative ignitor module system according to embodiments.

FIGS. 15a and 15b depict further alternative embodiments of an ignitor module.

FIG. 16 depicts an exploded view of a modular ignitor according to embodiments.

FIG. 17 depicts a cutaway view of the modular ignitor according to embodiments.

FIG. 18 depicts a view of the modular ignitor according to embodiments.

FIG. 19a and depict 19b cutaway exploded views of the modular ignitor according to embodiments.

FIG. 20a and 20b depict views of the modular ignitor according to embodiments.

The drawings are not necessarily to scale. The drawings are merely schematic representations, not intended to portray specific parameters of the disclosure. The drawings are intended to depict only typical embodiments of the disclosure, and therefore should not be considered as limiting the scope of the disclosure. In the drawings, like numbering represents like elements.

### DETAILED DESCRIPTION

Aspects of this disclosure include a fuse-less igniter system for fireworks. In one embodiment, the system includes an igniter module that is insertable through a wall or surface of a firework and replaces or augments a traditional fuse. The igniter module generally includes (1) a first end configured for exposure on the exterior surface or wall of the firework and includes a connection interface (2) a second end that is inserted into the firework proximate the pyrotechnic material of the firework, and (3) an internal ignition section at the second end configured to ignite the pyrotechnic material of the firework in response to an electrical signal received via the connection interface. The connection interface is configured to accept a plug or the like that connects wires to electrical igniter within the ignitor module.

In various embodiments, the igniter module can be manufactured as part of or be integrated into the wall of the firework itself, e.g., as a cap, as the lower portion of the firework, etc.

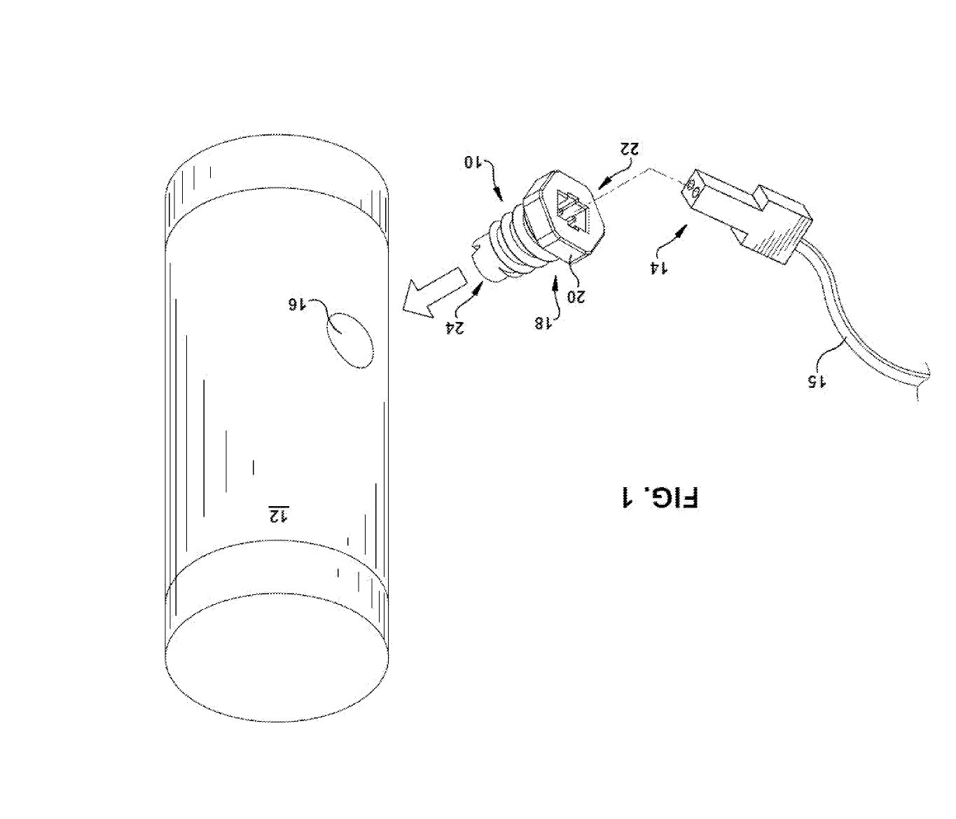

FIG. 1 depicts an illustrative embodiment of an ignitor module 10 that is configured for insertion into a firework 12 at an access point 16, e.g., in a pre-drilled hole, a scored area, an opening or other type access point. It is envisioned that the ignitor module 10 can be inserted into a cardboard wall of the firework 12 at the time the firework is manufactured, or any time after it is manufactured (e.g., by a third party or a user). Furthermore, the particular location of the access point 16 on the firework 12 may be selected on the firework surface to most effectively ensure ignition of the firework 12.

In this embodiment, ignitor module 10 includes a threaded shaft 18, a hex bolt head 20, a connection interface 22, and an ignition section 24. The threaded shaft 18 and hex bolt head 20 are configured to allow the ignitor module 10 to be easily screwed into the firework 12 by rotating the hex bolt head 20, e.g., with a tool or by hand. With the ignitor module 10 inserted into the firework 12, plug 14 can be inserted into the interface 22 to deliver an electrical charge via wires 15 and cause the ignition element 24 to ignite the firework 12.

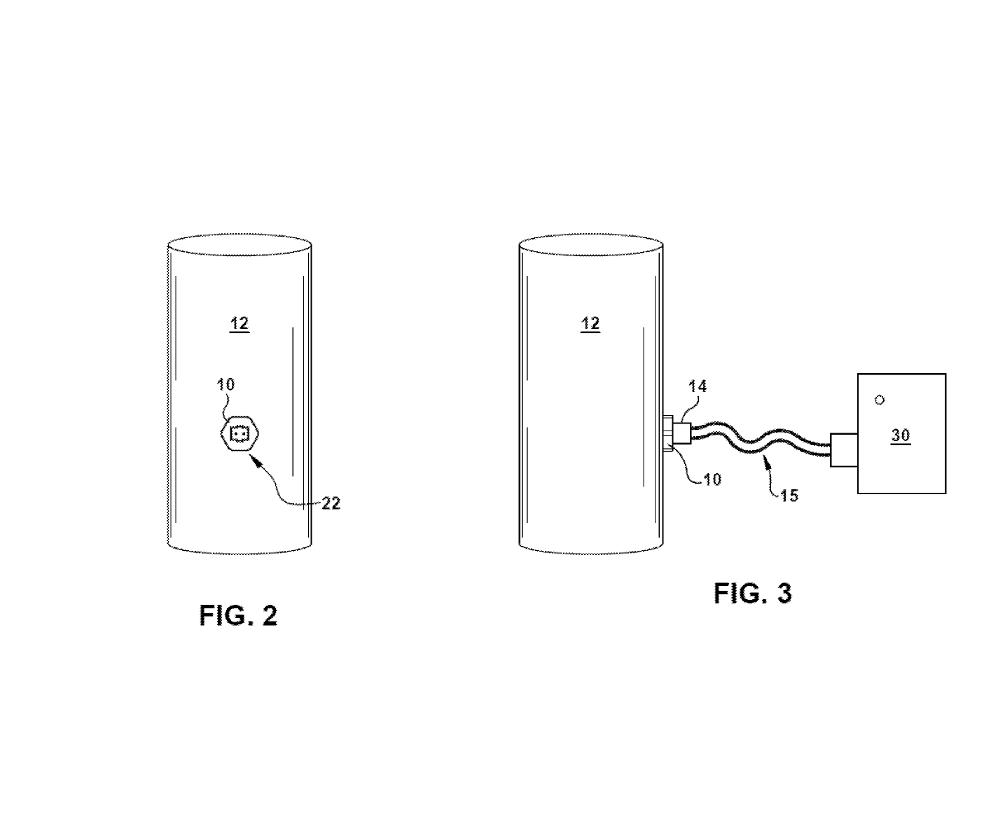

FIG. 2 shows a front view of the ignitor module 10 inserted into firework 12 with the connection interface 22 exposed on the surface of the firework 12. FIG. 3 depicts a side view of ignitor module 10 installed in firework 12. Also shown in FIG. 3 are plug 14 installed in interface 22 (not shown), wires 15 and a firing module 30. As shown, the wires 15 are configured to plug into the firing module 30 at a first end and the ignitor module 10/firework 12 at the other end. Firing module 30 may for example include multiple ports for connecting to multiple fireworks (not shown) and be remotely controlled by an App running on a smart device or some other type of master control system used in the industry. When instructed, the firing module 30 delivers an electrical current over the wires 15 to the ignitor module 10, which ignites the firework 12. In an alternative embodiment, the ignitor module 10 could include a pre-attached wire (rather than using a plug) configured to plug into a firing module 30.

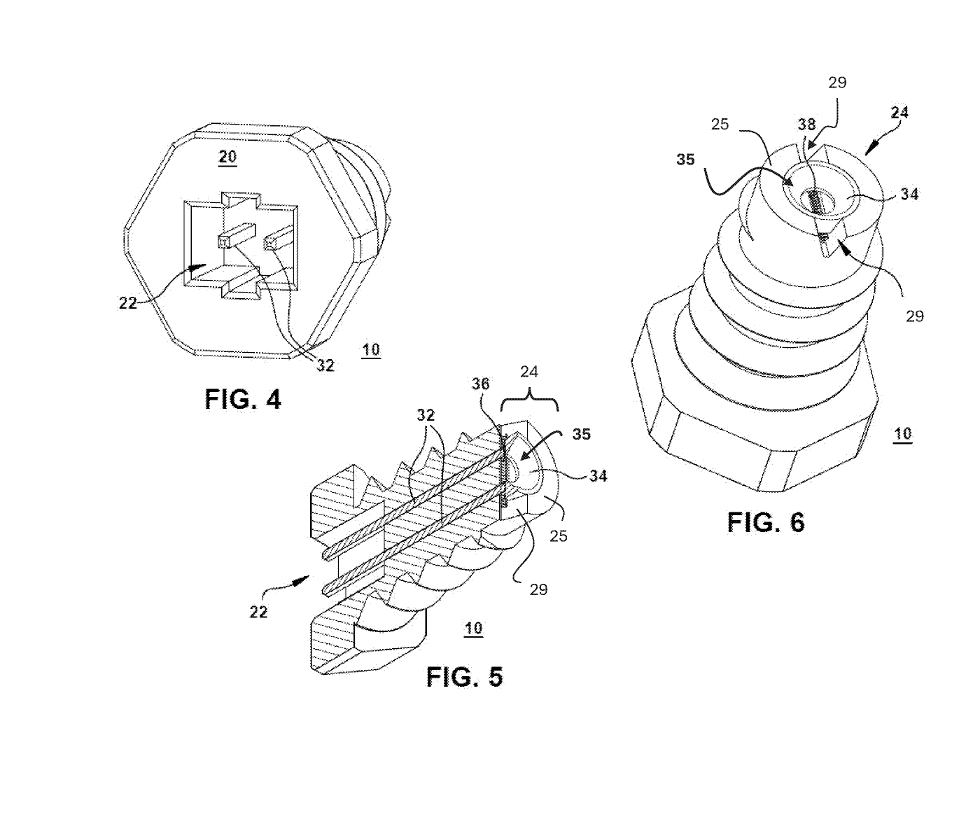

FIGS. 4-6 depict various views of an ignitor module 10 (without pyrotechnical material installed), which in this embodiment is manufactured with a hex bolt head 20 at a first end of the module and an ignition section 24 at a second end of the module 10. FIG. 4 depicts an isometric view of the ignitor module 10 showing the connection interface 22 recessed into the hex bolt head 20 with a pair of electrical conductors, in this case exposed metal “male” pins 32 are configured to mate with female receptacles in the plug 14 (FIG. 3). In certain embodiments, plug 14 may be releasably attachable to the interface 22 so that it can be readily installed and removed, e.g., by pressing a spring-loaded button. In other approaches, the plug 14 may mechanically snap or twist into the interface 22 in a predefined orientation to lock the plug 14 in place. In other aspects, non-mechanical electrical contacts may be utilized, such as a magnetic connection.

It is understood that any interface and plug configuration may be utilized to create a stable electrical connection with a set of (i.e., one or more) electrical contacts in the ignitor module. For example, in an alternative embodiment, male pins may be implemented within the plug 14 and female receptacles may be implemented within the interface 22. In another embodiment, rather than using a pin and receptacle configuration, electrical connections may be achieved with metal contacts that align on each of the plug 14 and interface 22. In other embodiments, electrical connections may be implemented via electrical induction. Accordingly, it is understood that any system for providing an electrical connection between plug 14 and interface 22 may be utilized.

FIG. 5 depicts a cutaway isometric view of module 10 and FIG. 6 depicts a non-cutaway isometric view, both showing elements of the ignition section 24 of module 10. Ignition section 24 generally includes: (1) a perimeter wall 25 that defines a recessed opening 35; (2) metal pins 32 (i.e., electrical conductors) that run from the interface 22 through module 10 and extend into the recessed opening 35; (3) a heating element 36, e.g., a coiled tungsten wire, positioned across the recessed opening 35 / between perimeter wall 25 that contacts the metal pins 32; (4) an insertable structure 34 secured within the recessed opening 35 and having a hole 38 at an inner end that exposes heating element 36 and an outer opening at the other end; and (5) a pyrotechnic material (not shown), such as a putty-like black powder packed into the insertable structure 34.

In this illustrative embodiment, the perimeter wall 25 includes cutout grooves 29 that align with metal pins 32. Heating element 26 extends across the recessed opening 35 /perimeter wall 25 and is positioned in grooves 29 in alignment with pins 32, ensuring that heating element 36 contacts the metal pins 32. In alternative embodiments, nubs, recesses, or other structures may be utilized within wall 25 to hold and/or position the heating element 36 in alignment with metal pins 32. In still a further alternative embodiment, two ends of the heating element 26 can be molded, twisted, or otherwise infused with perimeter wall 25.

During assembly, insertable structure 34 is pressed and secured in the recessed opening such that an inner end of structure 34 contacts and secures heating element 36 in the correct position. Insertable structure 34 includes a cavity into which a pyrotechnic material can be placed, which is exposed to the heating element 36 via hole 38 at the inner end. In one embodiment, insertable structure 34 comprises a bowl-shaped cavity having curved walls that taper toward the outer opening away from hole 38. In other embodiments, the cavity of insertable structure 34 may comprise a frustoconical shape having straight walls that taper from the hole 38 to the outward opening. In still further embodiments, rather than having a round cross-section, structure 34 or the associated cavity may be implemented with an oval or geometric cross-section. Similarly, hole 38 and/or the outer opening may be any shape.

In various embodiments, the described structure 34 includes inner walls that taper (either curved or straight) from hole 38 to a larger outer opening. Such a tapered configuration potentially enhances the efficacy of the explosion of the pyrotechnic material, as the explosion will be broadcast to a wider area. The tapered configuration also provides a funnel-shaped cavity that simplifies the loading of the pyrotechnic material into structure 34.

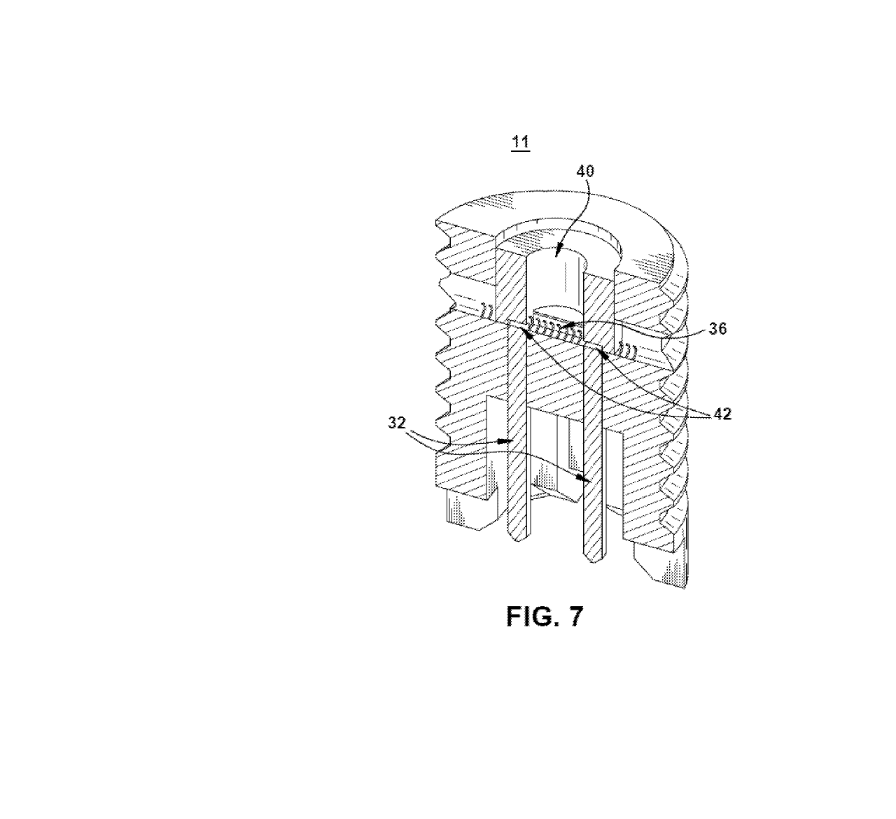

FIG. 7 depicts an alternative configuration of an ignitor module 11 in which the ignition section 24 includes a tubular insertable cavity 40 (i.e., with un-tapered walls) that is likewise friction-held in place. Like the embodiments shown in FIGS. 4-6, pins 32 extend through the module from the interface 22 to the heating element 36. Tubular shaped cavity 40 likewise contains pyrotechnic material (not shown) that ignites when the heating element 36 gets hot, in response to an electrical current.

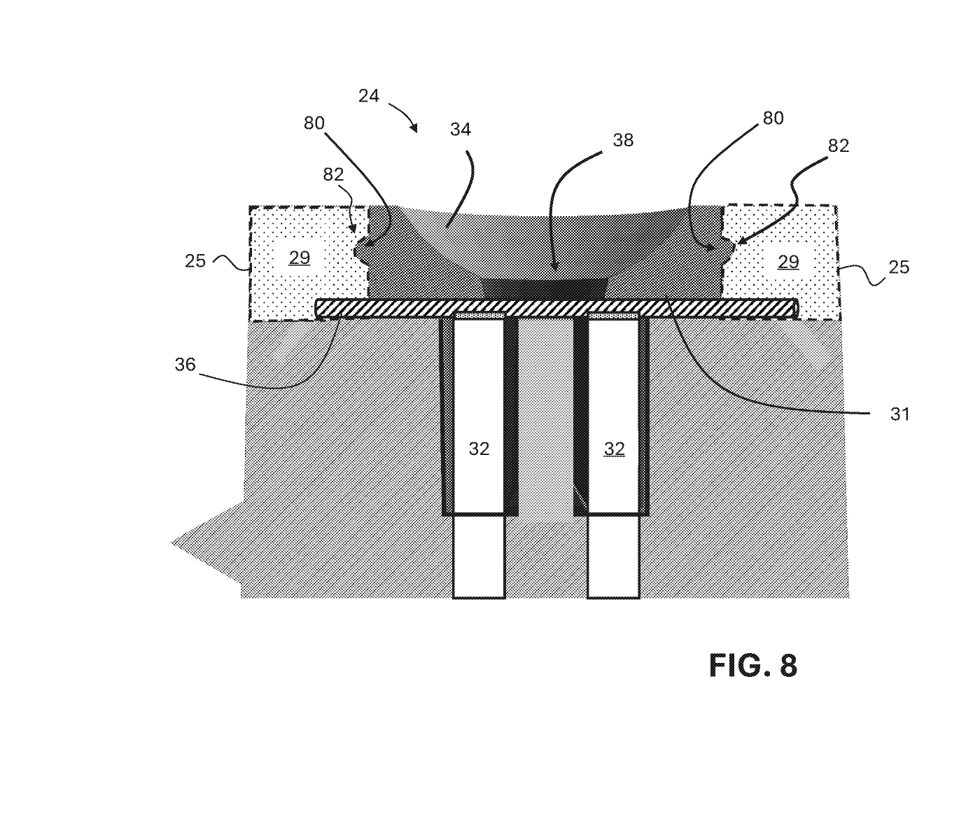

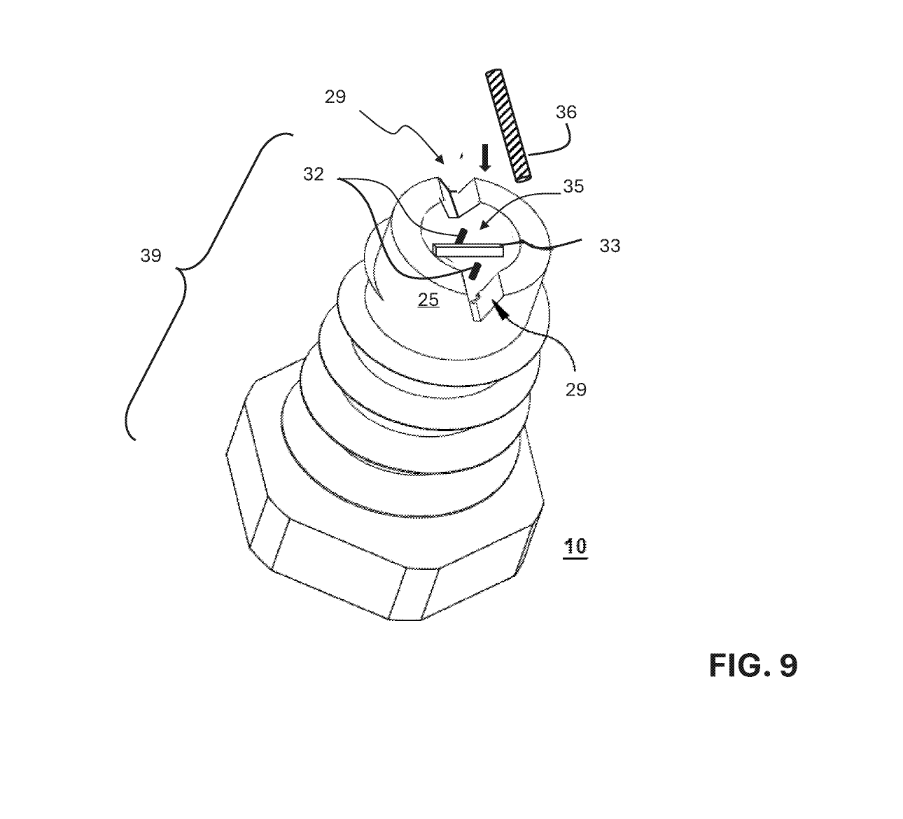

FIG. 8 depicts a cross-sectional view of the ignition section 24 of the embodiment shown in FIGS. 4-6, which shows pins 32 extending upward into the recessed opening formed within perimeter wall 25. As noted, insertable structure 34 is secured within the ignition section 24, which is shown by way of example using a rib 80 and channel 82 arrangement. As described herein, heating element 36 is seated within grooves 29 formed within perimeter wall 25 and extends laterally across the recessed opening and contacts pins 32. Insertable structure 34 is shown inserted within the recessed opening 35 within perimeter wall 25. In this case, a channel 82 circumscribes some or all of the inner surface of perimeter wall 25 and insertable structure 34 includes a complementary rib 80 that circumscribes some or all of an outer surface of the insertable structure 34. During assembly, insertable structure 34 is pressed into the recessed opening 35 and rib 80 that snaps into channel 82. In one aspect, rib 80 provides a friction-fit ring that holds the insertable structure 34 in place. An inner end 31 of structure 34, once inserted, presses and pinches heating element 36 in position to maintain the heating element 36 in firm contact against both metal pins 32.

It is understood that any number of variations to a mechanism may be utilized to secure insertable structure 34 in place. For example, channel 82 and rib 80 may be swapped between perimeter wall 25 and insertable structure 34. In other approaches, the external wall of insertable structure 34 and internal surface of perimeter wall 25 may be threaded allowing insertable structure 34 to be twisted therein. In yet other approaches, the internal surface of perimeter wall 25 may include any type of male or female fastener or latch to mate with an opposite male or female fastener or latch on the external wall of insertable structure 34. It is further understood that insertable structure 34 can be manufactured from any material, which may include a flexible plastic material that allows insertable structure 34 to be easily manipulated and snapped into place. In other embodiments, insertable structure 34 may be glued in place, adhered, or otherwise secured within the recessed opening.

FIGS. 9-11 depict a process of assembling the ignition section of ignitor module 10. FIG. 9 depicts an isometric view of the unfinished module, i.e., component 39, which includes perimeter wall 25 defining recessed opening 35 and pins 32 extending into recessed opening 35. This step of assembling the ignitor module from component 39 includes placing heating element 36 laterally across the perimeter wall 25 in cutout grooves 29. In this example, a separating wall 33 extends between the pair of pins 32 onto which the heating element 36 can rest.

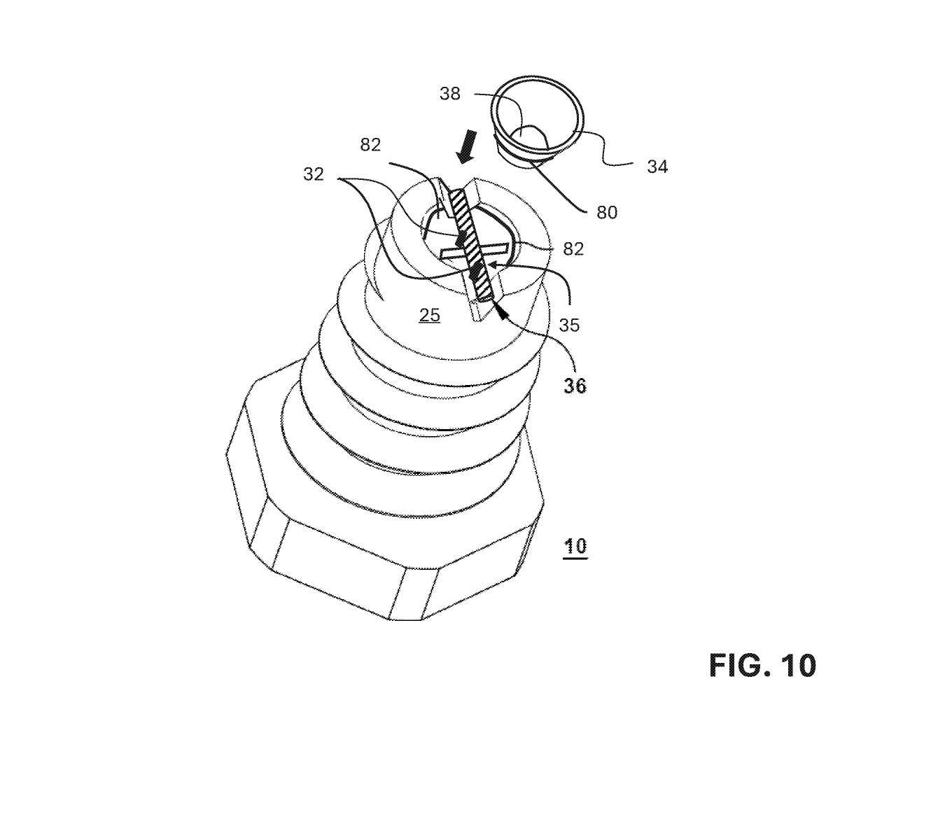

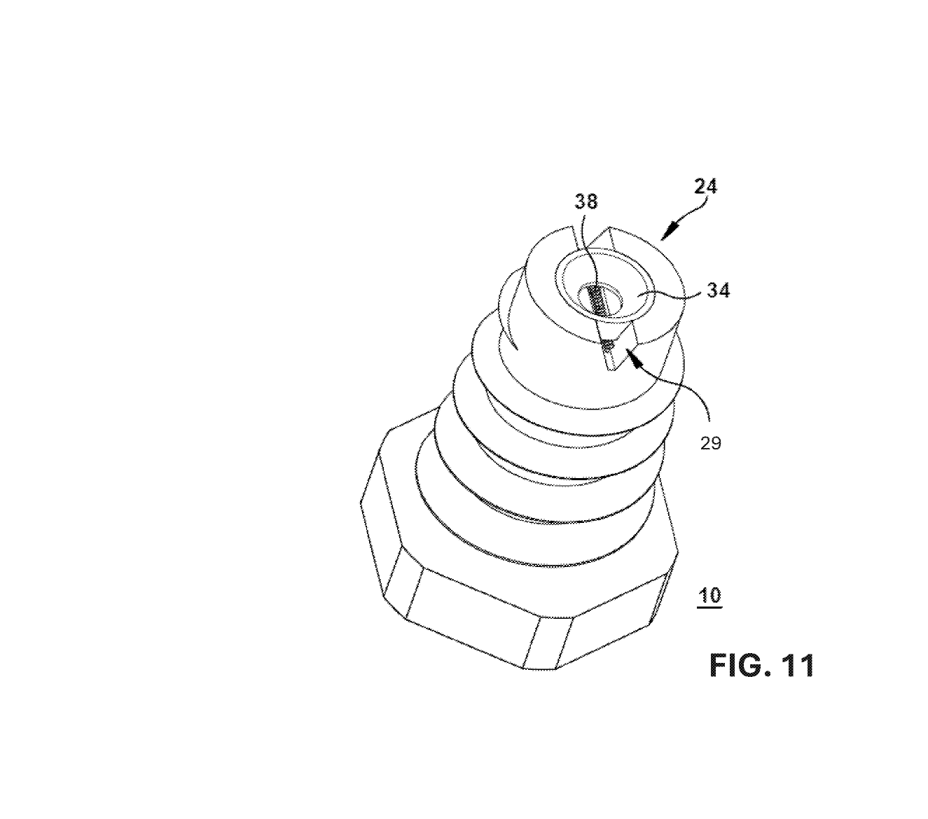

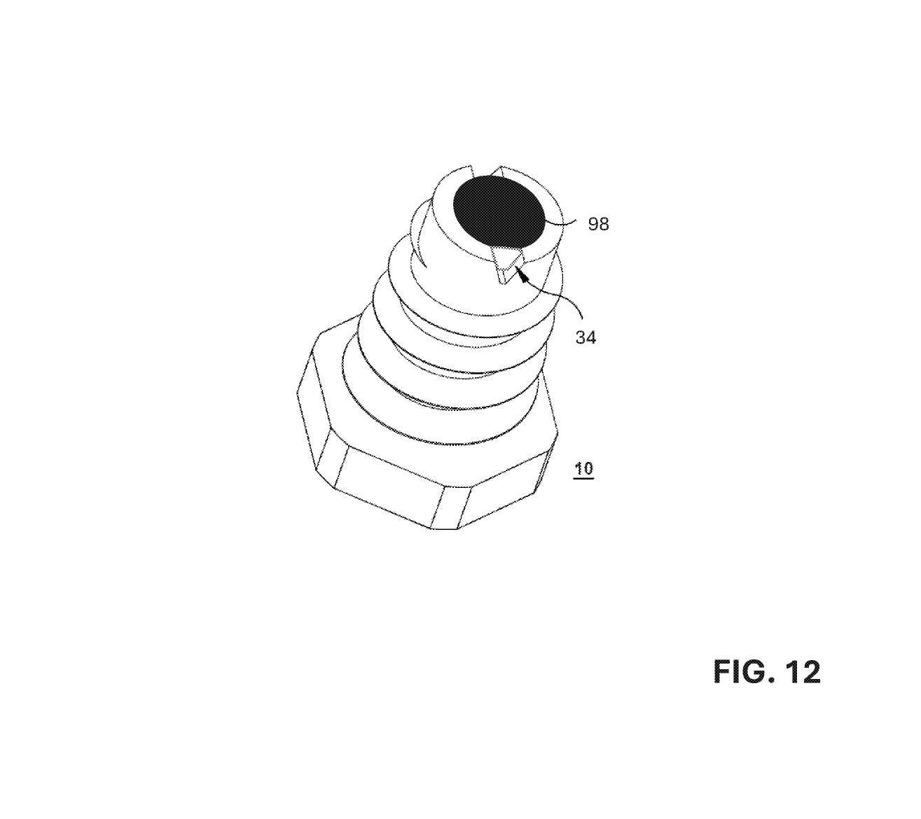

FIG. 10 shows a further assembly step with heating element 36 placed in cutout grooves 29. As shown, heating element 36 is placed in contact with pins 32. Next, insertable structure 34 is pressed and secured into recess 35, as shown by the arrow. During insertion, rib 80 on the external wall of insertable structure 34 snaps into channel 82 on the interior surface of perimeter wall 25, providing a friction-held secure arrangement. When inserted and secured in place, the inner end of insertable structure 34 proximate hole 38 pinches and holds heating element 36 in place, i.e., ensuring an electrical contact between pins 32 and heating element 36. The resulting module is shown in FIG. 11, in which insertable structure 34 is secured in place within the recess. Hole 38 at the inner end of insertable structure 34 exposes heating element 36. As also noted, the inner end of insertable structure 34 proximate hole 38 secures the heating element 36 in position. The inner end of insertable structure 34 may for instance pinch or crimp heating element 36 near cutout grooves 29 ensuring the heating element 36 does not move and remains in contact with pins 32. FIG. 12 shows module 10 with pyrotechnic material 98 placed into insertable structure 34. Pyrotechnic material may for example initially comprise a slurry that cures and hardens in the insertable structure 34. A coating such as shellac or varnish may be applied to the tip of the module to complete the assembly process.

In alternative embodiments, it is understood that any number of variations to the ignition section 24 may be utilized. For example, rather than using an insertable structure 34, 40, a container (e.g., a shaped bag or the like with tapered or straight walls) of pyrotechnic material may be secured into the end of module 10 proximate heating element 36. In other cases, a fuse may be integrated into the ignition section, e.g., a string or other material coated with a dried slurry of black powder and glue that can be ignited by heating element 36. In still other cases, some or all of the material that forms module 10 may be manufactured from an ignitable material, which can be ignited by heating element 36. In still other embodiments, the hole in insertable structure 34 could be replaced with a foil cap or the like that transfers the heat from the filament to the pyrotechnical material.

In yet other embodiments, rather than having a recessed opening, the pyrotechnical material could simply sit on the edge/outer surface of the ignition section 24 (proximate the heating element) and be held in place with a lacquer coating or the like. In a further embodiment, instead of using a separate structure that is placed into the recessed cavity, a captive "flap" or "strap" that is secured on one side of the perimeter wall could be utilized that folds over and snaps onto the end of the module to receive pyrotechnic material (similar to plastic water bottles that use captive caps to open and close the opening.)

In still a further approach, a separate insert may be pre-manufactured that includes two electrical conductors and a heating element affixed mechanically (e.g. via crimping or welding) to each conductor. The insert could be inserted into the body of a module and any of the aforementioned techniques for loading the module with pyrotechnic material could be utilized.

Regardless, when an electrical current is passed through the metal pins 32, the heating element 36 (e.g., tungsten coil) heats up to a red-hot state and ignites the pyrotechnic material. The ignited pyrotechnic material in turn lights and triggers the firework's initial effect.

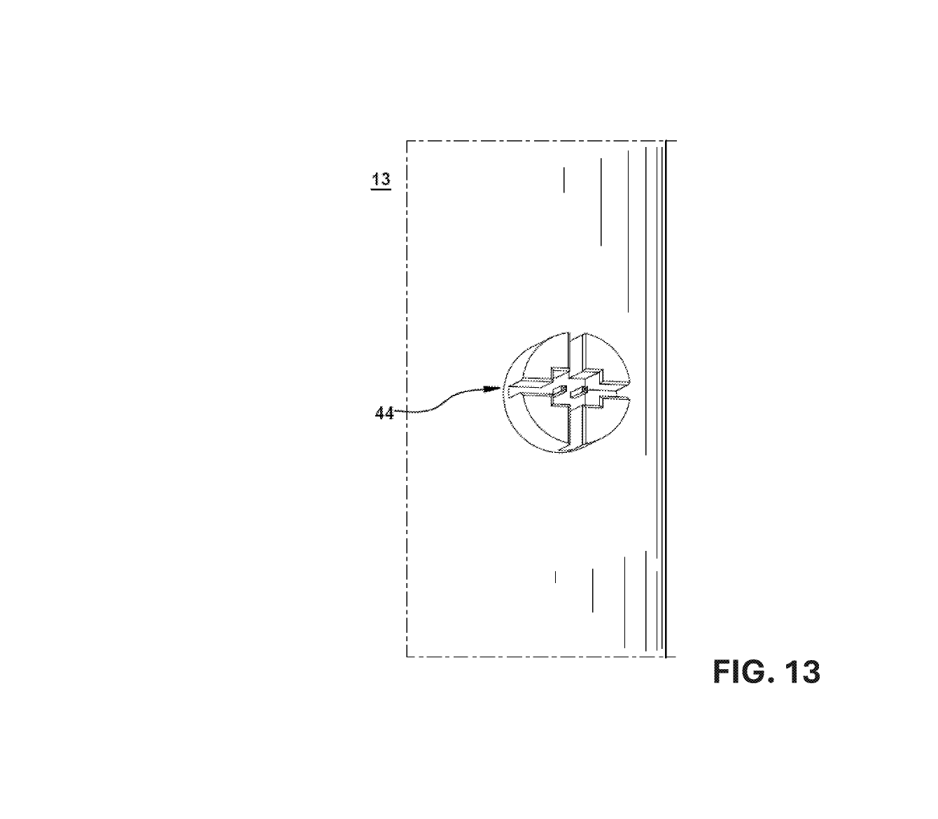

FIG. 13 depicts an alternative configuration of the interface end of an ignitor module 13, shown installed in a firework. In this embodiment, rather than utilizing a hex bolt head, a round head is used having a recessed surface, in this case a crossed recess 44 that is adapted to receive a specialized tool (e.g., a screwdriver) to rotate and insert the module. It is understood that the described hex bolt head 20 and crossed recess head 44 are not intended to be limiting and other configurations may be utilized. For example, while the described embodiments allow the module 10 to be “screwed” into the firework with a tool, it is understood that the module 10 may include any configuration or shape to support or facilitate insertion into a firework. Other such configurations may, e.g., include a rivet that utilizes a rivet gun, a head with pin holes that can receive a tool for rotation, a geometric head with more or less than six sides, a knobbed head, a star-shaped head, a concave or convex head profile, a tapered shaft, an un-tapered shaft, a shaft with a speared or pointed end, a shaft with toggle wings or anchors, a head with grooves that support a hand or machine press, etc.

Further, while the illustrative embodiment of ignitor module 10 may be formed from plastic as a threaded bolt, it is understood that other materials and configurations could be utilized. For example, module 10 could be formed from glass, paper, wood, silicone, fiber, a plant-based substance, a composite material, metal, etc. Furthermore, rather than using a threaded bolt, the external surface of module 10 may be formed with a pointed conical profile or other profile adapted to penetrate a wall or surface of a firework and maintain module 10 securely in place. In some aspects, the firework may be manufactured with a small pilot hole in the wall or surface to enable easy insertion of module 10. In other aspects, module 10 may be configured to puncture the wall or surface of the firework without a pilot hole. In certain embodiments, the interface 22 may include a removable cover, e.g., a piece of tape or plastic shield, to protect module 10 prior to use. In other embodiments, firework 12 may include a removable cover over the access point 16 (FIG. 1), e.g., a piece of tape or plastic shield, to protect the firework prior to module 10 insertion.

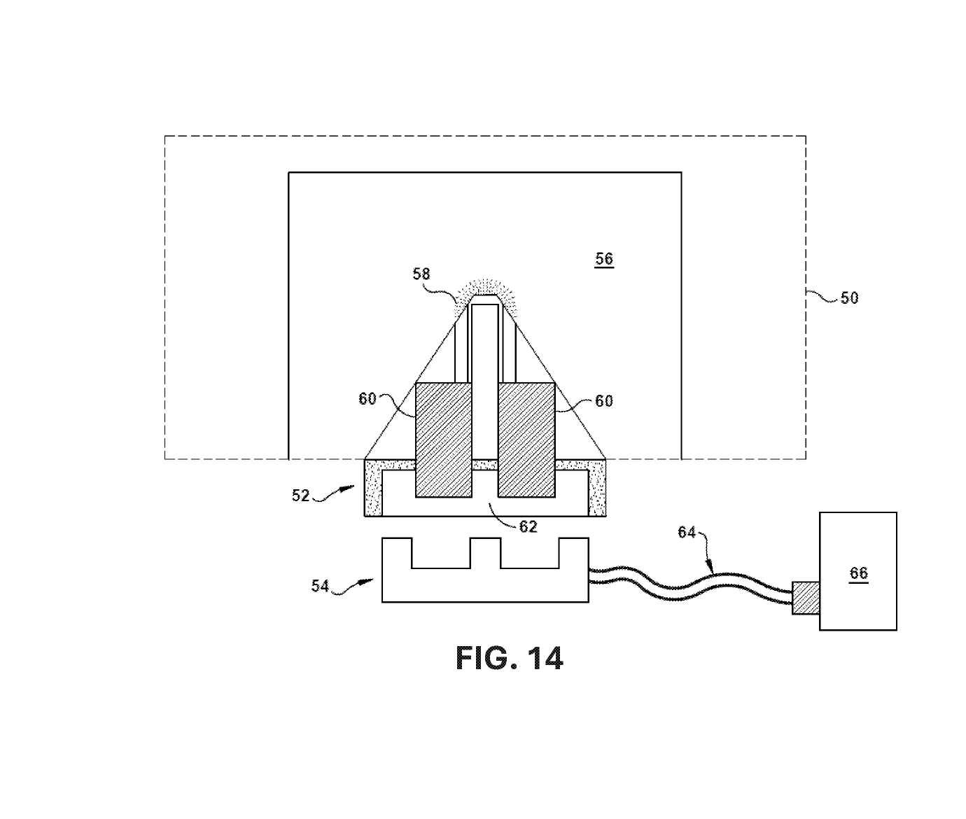

FIG. 14 depicts a top cutaway view of a further alternative embodiment of an ignitor module 52 installed in a firework 50. In this embodiment, the ignitor module 52 does not itself contain a pyrotechnic material, but instead is configured to directly ignite the firework pyrotechnic material 56 in the firework 50. Similar to the above embodiments, the ignitor module 52 includes an interface 62 having metal contacts 60 and receives a plug 54 coupled to a firing module 66 via a pair of wires 64. In this case, the heating element 58 includes an exposed region that directly contacts (or is sufficiently proximate to) firework pyrotechnic material 56. In this embodiment, when electricity from the firing module 66 causes the heating element 58 to heat, it directly ignites the firework 50.

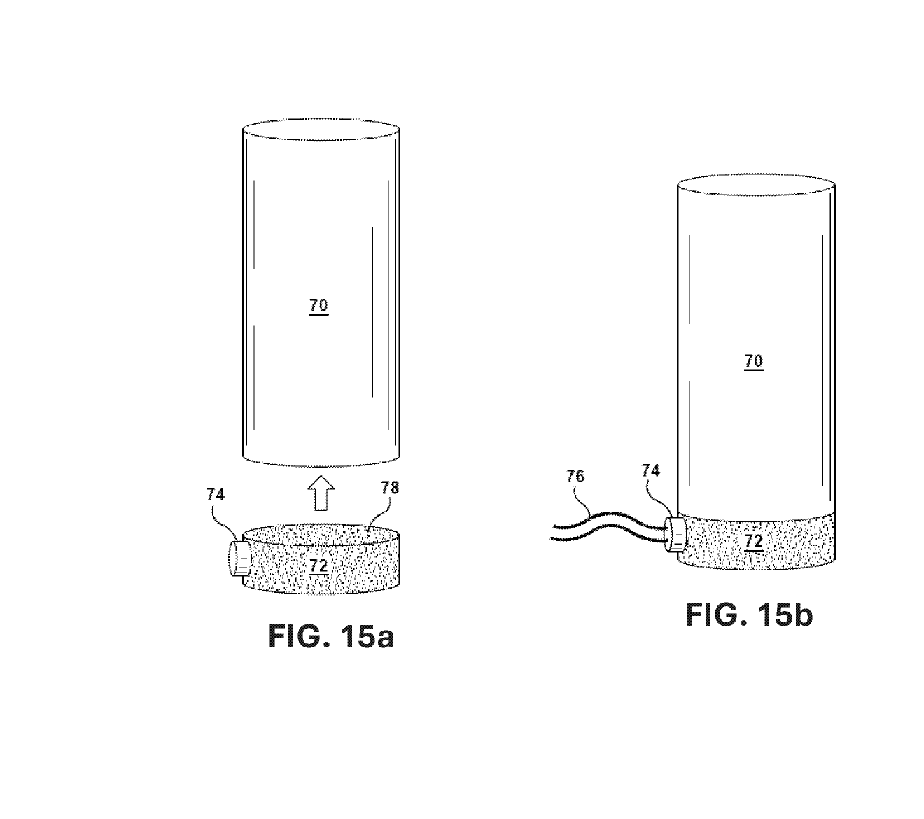

FIGS. 15a and 15b depict yet further embodiments of an alternative ignitor module 72. In this embodiment, the ignitor module 72 (as shown in FIG. 10a) is configured to attach to the bottom of a firework 70, e.g., using glue, clips, a lip, threading, etc. The ignitor module 72 may be attached to firework 70 during the firework manufacturing process, or thereafter. The ignitor module 72 may for example comprise a plastic container that fully incorporates an ignition system similar to module 10, e.g., including metal electrodes, a heating element (e.g., a coil), and an ignition element (e.g., a pyrotechnic material). In addition, ignitor module 72 includes an interface 74, i.e., universal receptacle, adapted to receive a wired plug 76, as shown in FIG. 15b. When the wired plug 76 is plugged into the interface 74 and an electrical current is passed therethrough from a firing module, the heating element ignites the pyrotechnic material in the module 72, which then ignites the firework 70. Although shown as a cylindrical shaped device that conforms to the bottom of the firework 70, it is understood that module 72 can comprise any shape or size that can readily attached to an outer surface of firework 70. It is also understood that module 72 can be made of any suitable material or materials, e.g., cardboard, glass, paper, wood, silicone, fiber, a plant-based substance, a composite material, metal, etc. Furthermore, it is understood that the interface region 78 of module 72 (i.e., where module 72 connects to firework 70) may be exposed or include a thin membrane of material to allow the pyrotechnic material contained therein to directionally blast (e.g., upward) and ignite the firework 70.

In yet a further alternative approach, module 72 could attach to the outer surface of the firework and cover a pre-drilled hole or the like. Thus, rather than being inserted, the module would direct its ignition through the hole of the firework from the outside.

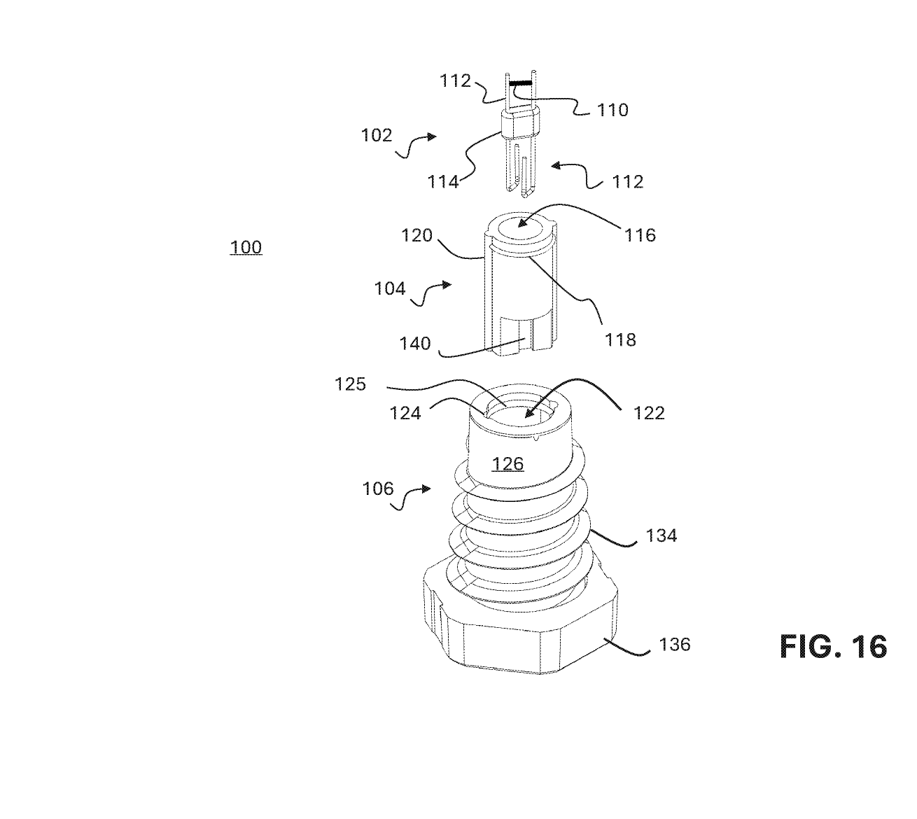

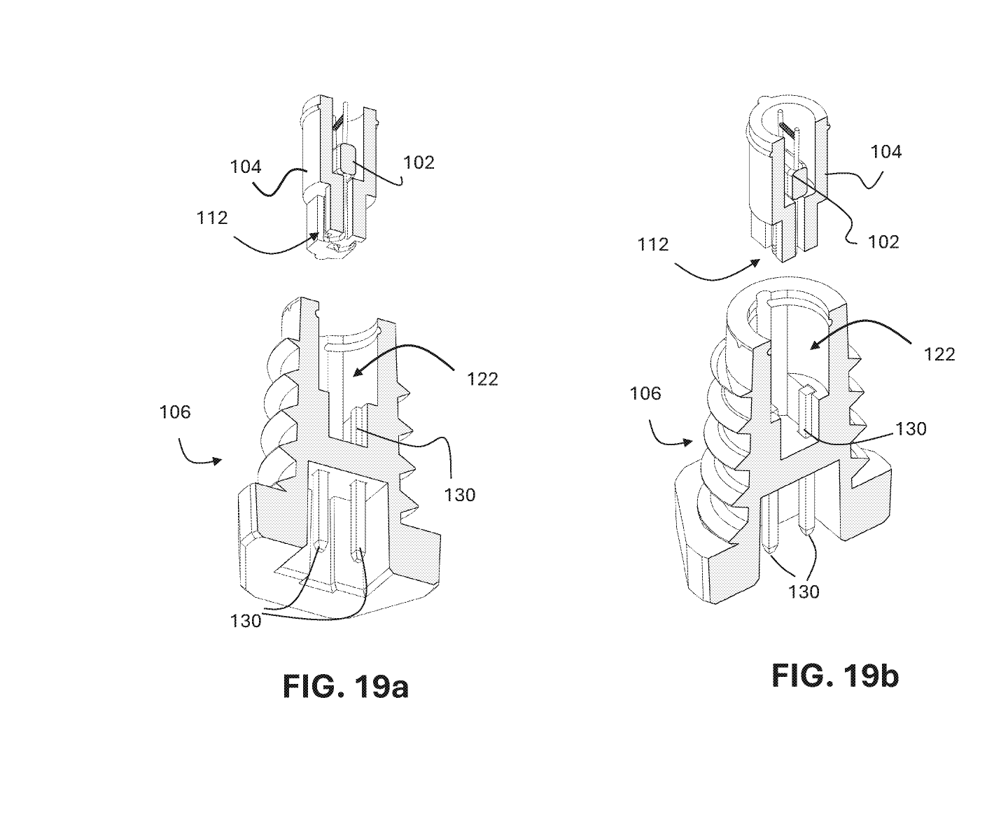

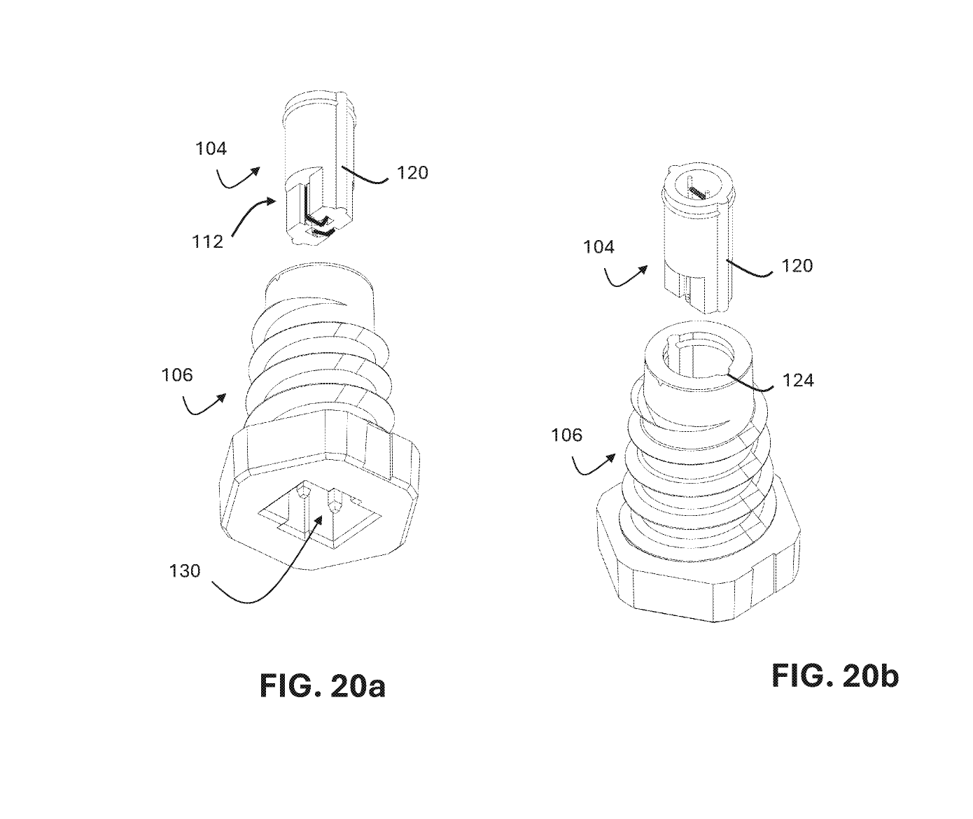

FIGS. 16-20b depict an embodiment of a three-part modular ignitor 100, which operates similar to the previous embodiments and may, in further alternative embodiments, include any of the previously described features or arrangements. The modular design of ignitor 100 may for example simplify the manufacturing and assembly process. FIG. 16 shows an exploded view of ignitor 100, which generally includes a socket component 106, a base component 104, and an ignition component 102, which can be easily assembled. Socket component 106 has a first end (e.g., as shown in FIG. 20a) exposing a pair of electrical conductors 130 configured for receiving a plug, and has a second end having a perimeter wall 126 that defines an opening 122 that internally exposes the pair of electrical conductors 130 (see, e.g., FIGS. 19a and 19b). Similar to the previous embodiments, socket component 106 may, e.g., include a threaded outer surface 134 and hexagon head 136 to facilitate installation into a firework.

Base component 104 is configured to be insertable into the opening 122 of socket component 106. In this embodiment, base component 104 includes flanges 120 that are slidable into grooves 124 of the socket component 106. Additionally, base component 104 may include a rib 118 that can engage into channel 125 of the socket component 106 to lock the two parts 104, 106 in place.

Ignition component 102 includes a pair of wires 112 having a heating element 110 coupled therebetween at an outer or “ignition” end of the wires 112. Ignition component 102 may also include a support structure 114 for holding the wires 112 in place. During assembly, the pair of wires 112 are configured to extend through recess 116 of the base component 104 such that the lower or “conductive” end of the wires 112 are folded around and exposed on an outer recessed surface 140 of the base component 104 (see, e.g., FIG. 20a). When fully assembled, the conductive ends of wires 112 are configured to be mechanically and electrically coupled to the pair of electrical conductors 130 in the opening 122 of the socket component 106, e.g., as shown in FIG. 19b.

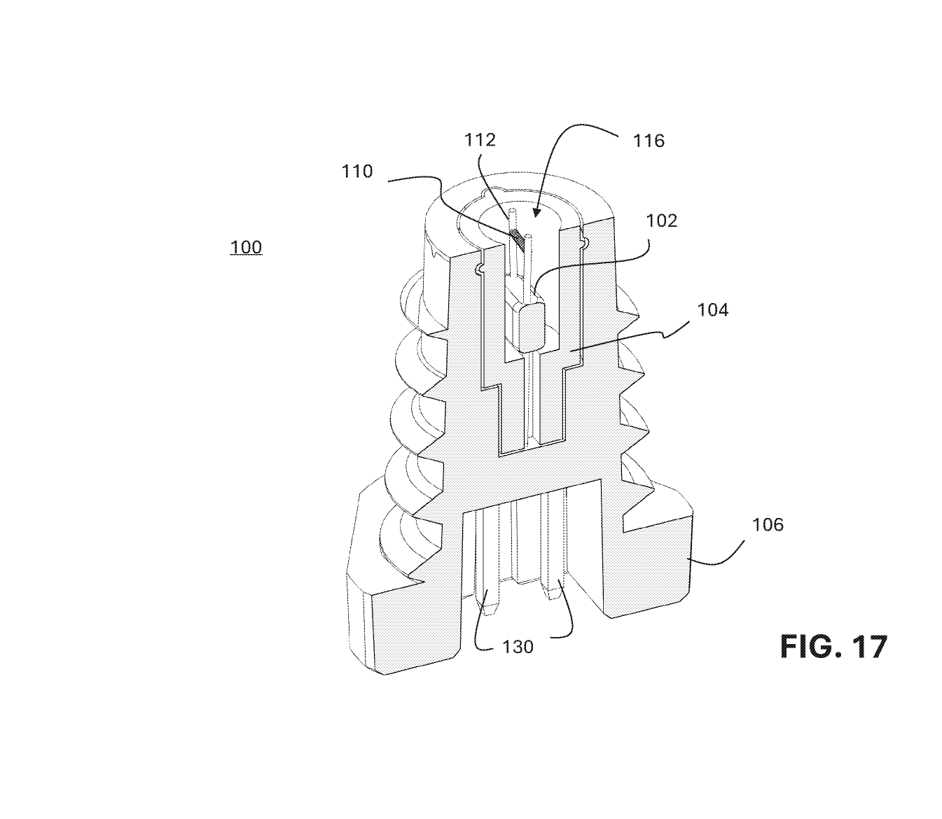

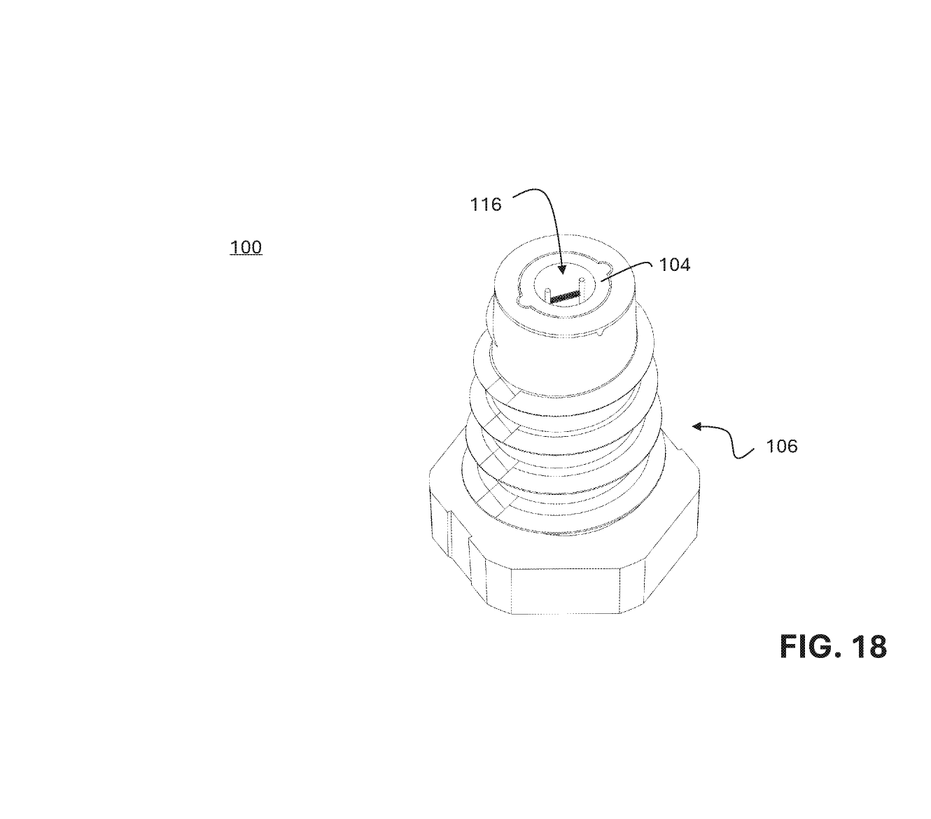

FIG. 17 depicts a cutaway view of ignitor 100 with base component 104 inserted in socket component 106, and ignitor component 102 inserted in base component 104. When an electrical current is passed through conductors 130, the current is passed to the conductive ends of wires 112 and on to the ignitor ends of wires 112, where heating element 110 heats up to ignite pyrotechnical material (not shown) held in or proximate the recess 116 of the base component 104. FIG. 18 shows a non-cutaway isometric view of ignitor 100.

FIGS. 19a and 19b show cut-away exploded views of ignitor 100 with the ignitor component 102 seated in base component 104. As shown, base component 104 includes a stepped exterior profile configured to engage with a stepped interior profile of socket component 106. Wires 112, which folded up on an outer recessed surface of base component 104 are accordingly positioned to electrically couple to conductors 130 within the opening 122 of socket component 106. FIGS. 20a and 20b show an exploded non-cutaway isometric view of ignitor 100. As can be seen in FIG. 20b, flanges 120 are provided to slidable engage with grooves 124 during the assembly process.

Note that while the described embodiments generally include a tungsten wire or the like to ignite the pyrotechnic material, ignition of the firework (either via pyrotechnic material in the module or via direct ignition) may be implemented with any type of heating element that can convert electrical energy into heat energy. For example, a device that generates an electric or plasma arc can be utilized. Arcing is for example a known technology used in welding and spark plugs.

This described igniter systems significantly streamline the set up and ignition process of fireworks shows, while enhancing safety by minimizing direct interaction with the firework. The system also eliminates the need for attaching talons to fuses, which can be time consuming and error prone.

In certain embodiments, fireworks incorporating ignitor modules described herein may be packaged with a firing system that for example includes one or more firing modules, wires/plugs, and a master controller and/or downloadable software for creating a firework show from a computer device, smartphone, etc.

In other embodiments, the ignitor module may include additional components to further enhance a firework show, e.g., an LED, specialized circuitry with a timing system, an audio output (e.g., a whistle, beep, or “fire in the hole”), etc.

The foregoing description of various aspects of the disclosure has been presented for purposes of illustration and description. It is not intended to be exhaustive or to limit the disclosure to the precise form disclosed, and obviously, many modifications and variations are possible. Such modifications and variations that may be apparent to an individual in the art are included within the scope of the disclosure as defined by the accompanying claims.

1. An ignitor module insertable into a firework, comprising:
a first end exposing a pair of electrical conductors configured for receiving a plug and a second end having a perimeter wall that defines a recessed opening into which the pair of electrical conductors extend;
a heating element positioned across the recessed opening in contact with the pair of electrical conductors;
an insertable structure secured within the recessed opening, wherein the insertable structure includes a cavity with a hole at an inner end that exposes a portion of the heating element, and wherein the inner end secures the heating element in position; and
a pyrotechnic material placed within the cavity of the insertable structure and being adapted to ignite in response to heat energy generated by the heating element.

2. The ignitor module of claim 1, wherein the heating element comprises a tungsten coil.

3. The ignitor module of claim 1, wherein the perimeter wall includes cutout grooves within which ends of the heating element are seated.

4. The ignitor module of claim 1, wherein the insertable structure comprises a bowl-shaped cavity with curved walls that taper from the hole to an outer opening.

5. The ignitor module of claim 1, wherein the insertable structure comprises a frustoconical shaped cavity with straight walls that taper from the hole to an outer opening.

6. The ignitor module of claim 1, wherein the insertable structure comprises a tubular cavity.

7. The ignitor module of claim 1, wherein the insertable structure includes a rib on an outer surface, and wherein the perimeter wall includes a channel on an inner surface that mates with the rib.

8. The ignitor module of claim 1, wherein the insertable structure is friction-held in place within the recessed opening.

9. The ignitor module of claim 1, wherein the insertable structure is glued in place within the recessed opening.

10. A method for manufacturing an ignitor module, comprising:
forming a component having a first end exposing a pair of electrical conductors configured for receiving a plug and a second end having a perimeter wall that defines a recessed opening into which the pair of electrical conductors extend;
placing a heating element laterally across the perimeter wall such that the heating element aligns with and contacts the pair of electrical conductors;
inserting an insertable structure into the recessed opening, wherein the insertable structure includes a friction-held component that contacts an inner surface of the perimeter wall to secure the insertable structure in place and includes a hole at an inner end that exposes the heating element; and
placing a pyrotechnic material in a cavity of the insertable structure.

11. The method of claim 10, wherein the insertable structure comprises one of:
a bowl-shaped structure with curved walls that taper outwardly from the hole;
a frustoconical structure with straight walls that taper outwardly from the hole; and
a tubular cavity.

12. The method of claim 10, wherein the insertable structure includes a rib on an outer surface and the perimeter wall includes a groove on an inner surface for receiving the rib, and wherein pressing the insertable structure into the recessed opening includes inserting the rib into the groove.

13. A modular ignitor insertable into a firework, comprising:
a socket component having a first end exposing a pair of electrical conductors configured for receiving a plug and a second end having a perimeter wall that defines an opening and exposes the pair of electrical conductors;
a base component insertable into the opening of the socket component; and
an ignition component mountable within a recessed opening of the base component, wherein the ignition component includes a pair of wires having ignition ends and conductive ends, wherein the ignition ends include a heating element coupled therebetween, and wherein the conductive ends of the pair of wires are configured to extend through the base component;
and wherein the conductive ends of the pair of wires electrically couple to the pair of electrical conductors in the opening of the socket component.

14. The modular ignitor of claim 13, wherein the base component includes flanges that slidably engage with a channel in the socket component.

15. The modular ignitor of claim 13, wherein the base component includes a rib that engages with a channel in the socket component.

16. The modular ignitor of claim 13, wherein the base component includes a pair of recessed outer surfaces for positioning the conductive ends of the pair of wires.

17. A method of assembling a modular ignitor for a firework, comprising:
providing a socket component having a first end exposing a pair of electrical conductors configured for receiving a plug and a second end having a perimeter wall that defines an opening and exposes the pair of electrical conductors;
inserting an ignition component into a recessed opening of a base component, wherein the ignition component includes a pair of wires having ignition ends and conductive ends, wherein the ignition ends include a heating element coupled therebetween, and wherein the conductive ends of the pair of wires are extended through the base component; and
inserting the base component into the opening of the socket component, wherein the conductive ends of the pair of wires of the ignition component electrically couple to the pair of electrical conductors in the opening of the socket component.

18. The method of claim 17, wherein the base component includes flanges that slidably engage with a channel in the socket component.

19. The method of claim 17, wherein the base component includes a rib that engages with a channel in the socket component.

20. The method of claim 17, wherein the base component includes a pair of recessed outer surfaces for positioning the conductive ends of the pair of wires.
